(19) United States
(12) Patent Application Publication
(10) Pub. No.: US 2010/0315517 A1
(43) Pub. Date: Dec. 16, 2010

(54) IMAGE RECORDING DEVICE AND IMAGE RECORDING METHOD

(76) Inventors: Satoshi Nakamura, Miyagi (JP); Mikio Watanabe, Miyagi (JP); Satoru Okamoto, Miyagi (JP); Toshiharu Ueno, Miyagi (JP)

Correspondence Address: BIRCH STEWART KOLASCH & BIRCH, PO BOX 747, FALLS CHURCH, VA, 22040-0747, US

(21) Appl. No.: 12/521,511

(22) PCT Filed: Dec. 27, 2007
(86) PCT No.: PCT/JP2007/075409

§ 371 Date: Jun. 26, 2009

(30) Foreign Application Priority Data
Dec. 27, 2006 (JP) 2006-353209

(51) Int. Cl. H04N 5/225

(52) U.S. Cl. 348/207.99; 348/E05.024

(57) ABSTRACT

An image recording device comprises: an image data acquiring unit which acquires first image data (1) defined by a standard format, and at least one second image data (2, 3 . . . ) defined by the standard format; a related information generating device which generates a related information relating to at least two image data from among the first and second image data; a recording image file generating unit which generates a recording image file including a first image data area (A1) having the first image data (1) stored therein, a second image data area (A2) having the second image data (2, 3 . . . ) stored therein, and a related information recording area (A3) having the related information stored therein; and a recording unit which records the recording image file.

### TECHNICAL FIELD

The present invention relates to an image recording device and an image recording method, and specifically relates to a technology for storing a plurality of image data in one image file.

### BACKGROUND ART

Japanese Patent Laid-Open No. 2003-299016 discloses a digital storage device including a header, image data, and an image tail, and a digital image decoding system.

Depending on the use of the image file, a plurality of image data may be stored in one image file. When a plurality of image data stored in one image file is processed, the processing can be eased by acquiring related information that is in common to those image data, and controlling the processing content using the related information. However, conventionally, it has been impossible to easily reference related information on a plurality of image data contained in one image file. For example, Japanese Patent Laid-Open No. 2003-299016 does not disclose processing image data and data stored in an image tail based on related information that is in common to both.

### DISCLOSURE OF THE INVENTION

The present invention has been made in view of such circumstances, and an object of the present invention is to provide an image recording device and an image recording method that enable easy reference to related information on a plurality of image data when storing the plurality of image data in one image file.

In order to achieve the above object, an image recording device according to a first aspect of the present invention comprises: an image data acquiring unit which acquires first image data defined by a standard format, and at least one second image data defined by the standard format; a related information generating unit which generates a related information relating to at least two image data from among the first and second image data; a recording image file generating unit which generates a recording image file including a first image data area having the first image data stored therein, a second image data area having the second image data stored therein, and related information recording area having the related information stored therein; and a recording unit which records the recording image file.

According to the first aspect, related information which is common to a plurality of image data can easily be recorded in a recording image file storing the plurality of image data.

According to a second aspect of the present invention, in the image recording device according to the first aspect, the image data acquiring unit acquires image data of an identical subject photographed from multiple viewpoints using one or more photographing devices.

According to a third aspect of the present invention, in the image recording device according to the second aspect, the related information generating unit generates, based on the image data, an image combination information relating to a combination of images to be used when outputting a stereoscopic image; and the recording image file generating unit stores the image combination information in the related information storing area.

According to the third aspect, when storing parallax images photographed from multiple viewpoints for a stereoscopic view in one recording image file, related information used for generating image data for stereoscopic display in the same file.

According to a fourth aspect of the present invention, in the image recording device according to the third aspect, further comprises an image selecting unit which selects at least two of the image data based on the related information; and a stereoscopic image outputting unit which converts the selected image data into a format enabling a stereoscopic view and outputs it.

According to a fifth aspect of the present invention, in the image recording device according to the fourth aspect, the related information generating unit, when the selected image data is output to the stereoscopic image outputting unit, generates a reference history information indicating a history of the selected image data being output and referenced; and the recording image file generating unit stores the reference history information in the related information storing area.

According to the fifth aspect, by referencing the reference history information on each of a plurality of image data in a recording image file including the plurality of image data, for example, an optimum image data combination or the like can be selected according to the three-dimensional display function of an output destination device.

According to a sixth aspect of the present invention, in the image recording device according to any of the second to fifth aspects, the related information generating unit generates distance data indicating the distances to the subject at the time of photographing the plurality of image data, based on the plurality of image data; and the recording image file generating unit stores the distance data in the related information storing area.

According to a seventh aspect of the present invention, in the image recording device according to the sixth aspect, the distance data is distance histogram data or distance image data generated based on the plurality of image data.

According to the sixth and seventh aspects, by storing distance data in a recording image file as related information, the validity of a distance calculation based on an image data combination used for calculating the distance data can be judged based on its deviation from a reference value for the distance data. For example, when editing an image data or stereoscopically displaying an image data, the stereoscopic display can be conducted with a more realistic sensation by using an image data combination with high distance calculation validity.

According to an eighth aspect of the present invention, the image recording device according to any of the first to seventh aspects further comprises an editing unit which edits the first and second image data, and the related information generating unit generates an editing history information indicating the content of the editing performed on the first or second image data, when the first or second image data is edited, and the recording image file generating unit stores the editing history information in the related information storing area.

According to the eighth aspect, by storing editing history information on each of a plurality of image data in a recording image file containing the plurality of image data, for example, the same editing processing can be made on the plurality of image data, or the recording image file can also be restored to the state before the editing processing using the editing history information.

According to a ninth aspect of the present invention, the image recording device according to any of the first to eight aspects, further comprises an alteration detection data generating unit which generates alteration detection data for detecting an alteration of the first and second image data, and the related information, and the recording image file generating unit stores the alteration detection data in the related information storing area.

According to the ninth aspect, when transmitting image data for recording to another user, whether or not an alteration of the recording image file received by that transmission destination user has occurred on the communication path can be confirmed.

According to a tenth aspect of the present invention, an image recording method comprises: an image data acquisition step of acquiring first image data defined by a standard format, and at least one second image data defined by the standard format; a related information generation step of generating a related information relating to at least two image data from among the first and second image data; a recording image file generation step of generating a recording image file having a first image data area having the first image data stored therein, a second image data area having the second image data stored therein, and related information recording area having the related information stored therein; and recording step of recording the recording image file.

According to an eleventh aspect of the present invention, in the image recording method according to the tenth aspect, in the image data acquisition step, image data of an identical subject photographed from multiple viewpoints using one or more photographing means is acquired.

According to a twelfth aspect of the present invention, in the image recording method according to the eleventh aspect, in the related information generation step, an image combination information relating to a combination of images to be used is generated based on the image data when outputting a stereoscopic image; and in the recording image file generation step, the image combination information is stored in the related information storing area.

According to a thirteenth aspect of the present invention, the image recording method according to the twelfth aspect further comprises an image selection step of selecting at least two of the image data based on the related information; and a step of converting the selected image data into a format enabling a stereoscopic view, and outputting the converted image data to a stereoscopic image outputting device.

According to an fourteenth aspect of the present invention, in the image recording method according to the thirteenth aspect, in the related information generation step, when the selected image data is output to the stereoscopic image outputting device, a reference history information indicating a history of the selected image data being output and referenced is generated; and in the recording image file generation step, the reference history information is stored in the related information storing area.

According to a fifteenth aspect of the present invention, in the image recording method according to any of the eleventh to fourteenth aspects, in the related information generation step, distance data indicating the distances to the subject at the time of photographing the plurality of image data is generated based on the plurality of image data; and in the recording image file generation step, the distance data is stored in the related information storing area.

According to a sixteenth aspect of the present invention, in the image recording method according to the fifteenth aspect, the distance data is distance histogram data or distance image data generated based on the plurality of image data.

According to a seventeenth aspect of the present invention, the image recording method according to any of the tenth to sixteenth aspects further comprises an editing step of editing the first and second image data, and in the related information generation step, when the first or second image data is edited, an editing history information indicating the content of the editing performed on the first or second image data is generated; and in the recording image file generation step, the editing history information is stored in the related information storing area.

According to an eighteen aspect of the present invention, the image recording method according to any of the tenth to seventh aspects further comprises an alteration detection data generation step of generating alteration detection data for detecting an alteration of the first and second image data, and the related information, and in the recording image file generation step, the alteration detection data is stored in the related information storing area.

According to the aspects of the present invention, related information that is common to a plurality of image data can easily be recorded in a recording image file containing the plurality of image data. Also, according to the aspects of the present invention, when storing parallax images photographed from a plurality of viewpoints for a stereoscopic view in one recording image file, related information to be used for generating image data for stereoscopic display can be stored in the same file.

### BRIEF DESCRIPTION OF THE DRAWINGS

FIG. 1 is a diagram illustrating the configuration of a recording image file according to a first embodiment of the present invention;

FIG. 2 is a block diagram illustrating the main configuration of a photographing apparatus including an image recording device according to the first embodiment of the present invention;

FIG. 3 is a diagram illustrating the configuration of related information;

FIGS. 4A to 4F show diagrams illustrating an image data example;

FIGS. 5A to 5C show diagrams each illustrating distance histogram data generated from the image data in FIGS. 4A to 4F;

FIG. 6 is a flowchart illustrating a process of generating distance histogram data;

FIG. 7 is a graph showing distance histogram data calculated for a plurality of corresponding points;

FIG. 8 is a diagram illustrating an example of storing distance images indicating distances to a subject at the time of photographing as related information;

FIG. 9 is a diagram illustrating an example of storing a depth image as related information;

FIGS. 10A and 10B show diagrams illustrating the configuration of a recording image file according to a second embodiment of the present invention;

FIG. 11 is a diagram illustrating an example of editing history information;

FIGS. 12A to 12C show diagrams schematically illustrating editing processing for a recording image file F12;

FIG. 13 is a flowchart illustrating a process of editing the recording image file F12;

FIG. 14 is a diagram illustrating the configuration of a recording image file according to a third embodiment of the present invention;

FIG. 15 is a diagram illustrating reference history information; and

FIG. 16 is a diagram illustrating an example of storing alteration detection data as related information.

### DESCRIPTION OF SYMBOLS

1 . . . photographing apparatus
10 . . . photographing unit
12 . . . main CPU
14 . . . operating unit
16 . . . power control unit
18 . . . battery
20 . . . bus
22 . . . ROM
24 . . . flash ROM
26 . . . SDRAM
28 . . . VRAM
30 . . . monitor
32 . . . display control unit
34 . . . 2D/3D mode switching flag
36 . . . flash light-emitting unit
38 . . . flash control unit
40 . . . photographing lens
42 . . . zoom lens
44 . . . focus lens
46 . . . diaphragm
42C . . . zoom lens control unit (z lens control unit)
44C . . . focus lens control unit (f lens control unit)
46C . . . diaphragm control unit
48 . . . image sensor
50 . . . timing generator (TG)
52 . . . analog signal processing unit
54 . . . A/D converter
56 . . . image input controller
58 . . . digital signal processing unit
60 . . . AF detection unit
62 . . . AE/AWB detection unit
64 . . . compression/expansion processing unit
66 . . . image file generation unit
68 . . . media control unit
70 . . . memory card

### BEST MODE FOR CARRYING OUT THE INVENTION

Hereinafter, preferred embodiments of an image recording device and image recording method according to the present invention are described with reference to the attached drawings.

### First Embodiment

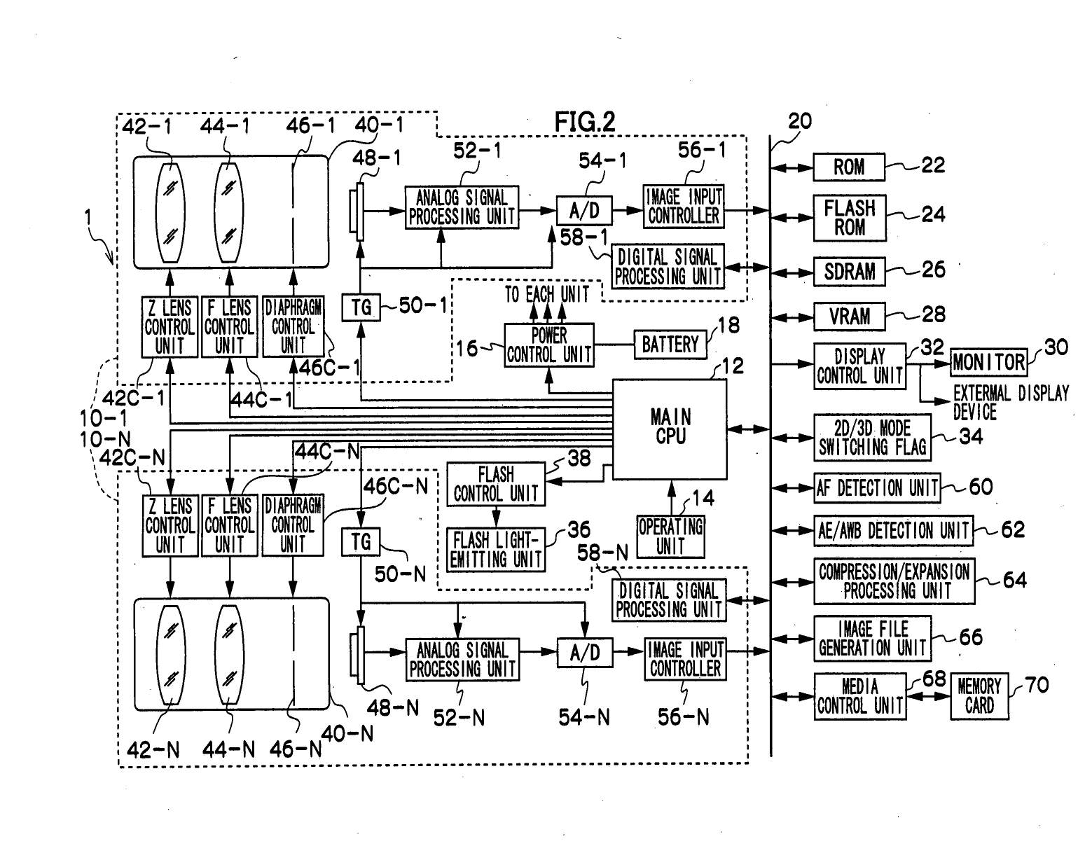

FIG. 2 is a block diagram illustrating the main configuration of a photographing apparatus including an image recording device according to a first embodiment of the present invention. As shown in FIG. 2, the photographing apparatus 1 includes a plurality of photographing units 10-1, 10-2, . . . 10-N (N≧2), and it is an apparatus that acquires parallax images of the same subject photographed from multiple viewpoints and records them as a recording image file in a predetermined format.

A main CPU 12 (hereinafter referred to as the “CPU 12”) functions as control means for integrally controlling the overall operation of the photographing apparatus 1 according to a predetermined control program, based on an input from an operating unit 14. A power control unit 16 controls the power from a battery 18 to supply operating power to each unit of the photographing apparatus 1.

The CPU 12 is connected to ROM 22, flash ROM 24, SDRAM 26 and VRAM 28 via a bus 20. The ROM 22 stores the control program executed by the CPU12, and various kinds of data necessary for control, and so on. The flash ROM 24 stores various kinds of setting information relating to the photographing apparatus 1 operation, such as setting information for a user.

The SDRAM 26 includes a computation area for the CPU 12 and a temporary storage area (work memory) for image data. The VRAM28 includes a temporary storage area dedicated to image data for display.

A monitor 30 is composed of, for example, a display device such as a color liquid-crystal panel, and is used as an image display unit for displaying a photographed image, and is also used as a GUI during making various kinds of settings. Furthermore, the monitor 30 is used as an electronic finder for confirming a field angle during photographing mode. On the surface of the monitor 30, what is called a lenticular lens having a group of hog-backed lenses is disposed, and a user can view a three-dimensional image (3D image) stereoscopically when that image is displayed. A display control unit 32 converts image data read from an image sensor 48 or a memory card 70 to image signals for display (for example, NTSC signals, PAL signals or SCAM signals), and outputs them to the monitor 30, and also outputs predetermined characters and graphic information (for example, on-screen display data) to the monitor 30. In addition, a display control unit 32 can output an image to an external display device connected via a predetermined interface (for example, USB, IEEE1394, or LAN).

The operating unit 14 includes operation input means, such as a shutter button, a power/mode switch, a mode dial, crosshair buttons, a zoom button, a MENU/OK button, a DISP button, and a BACK button.

The power/mode switch functions as means for on/off switching of power for the photographing apparatus 1, and means for switching operating modes (replay mode and photographing mode) of the photographing apparatus 1.

The mode dial is operation means for switching photographing modes of the photographing apparatus 1, and the photographing modes are switched between a 2D still image photographing mode in which a two-dimensional still image is photographed, a 2D moving image photographing mode in which a two-dimensional moving image is photographed, a 3D still image photographing mode in which a three-dimensional still image is photographed, and a 3D moving image photographing mode in which a three-dimensional moving image is photographed, according to the position where the mode dial is set. When the photographing mode is set to the 2D still image photographing mode or the 2D moving image photographing mode, a flag representing a 2D mode for photographing a two-dimensional image is set in a 2D/3D mode switching flag 34. In addition, when the photographing mode is set to the 3D still image photographing mode or the 3D moving image photographing mode, a flag representing a 3D mode for photographing a three-dimensional image is set in the 2D/3D mode switching flag 34. Referring to the 2D/3D mode switching flag 34, the CPU 12 judges whether the mode is the 2D mode or the 3D mode.

The shutter button consists of a two-step stroke-type switch: what are called “half press” and “full press”. In a still image photographing mode, when the shutter button is pressed halfway, photographing preparation processing (i.e., AE [Automatic Exposure], AF [Automatic Focusing], and AWB [Automatic White Balancing]) is performed, and when the shutter button is fully pressed, the processing for photographing and recording an image is performed. Also, in a moving image photographing mode, when the shutter button is fully pressed, the photographing of a moving image is started, and when the shutter button is fully pressed again, the photographing is finished. It is also possible to configure the settings so that the photographing of a moving image is conducted during the shutter button being fully pressed, and the photographing is finished when the full pressing is quitted. Furthermore, a still image photographing shutter button and a moving image photographing shutter button may be provided separately.

The crosshair buttons are provided in such a manner that it can be pressed in four directions: upward, downward, rightward and leftward directions. The button in each direction is assigned with a function that responds to the photographing apparatus 1 operating mode, or the like. For example, in photographing mode, the left-side button is assigned with a function that switches the on/off of the macro feature, and the right-side button is assigned with a function that switches the flash modes. Also, in photographing mode, the upside button is assigned with a function that changes the brightness of the monitor 30, and the downside button is assigned with a function that switches the on/off of a self timer. In replay mode, the left-side button is assigned with a frame advance function, and the right-side button is assigned with a frame return function. Also, in replay mode, the upside button is provided with a function that changes the brightness of the monitor 30, and the downside button is assigned with a function that erases the image that is being replayed. Also, when performing various settings, the buttons are each assigned with a function that moves the cursor displayed on the monitor 30 in the respective button's direction.

The zoom button is operation means for performing a zooming operation for the photographing units 10-1, 10-2, . . . 10-N, and it includes a zoom-tele button for instructing zooming to a telescopic view side, and a zoom wide angle button for instructing zooming to a wider angle.

The MENU/OK button is used for calling a menu screen (MENU function), and also used for determining the selected content, giving an instruction to execute processing (OK function) and so on, and its assigned function is switched according to the settings for the photographing apparatus 1. On the menu screen, the MENU/OK button performs the settings for all of the adjustment items the photographing apparatus 1 has, including, for example, image quality adjustments such as the exposure value, the color shade, the photographic sensitivity, and the recording pixel count, the self timer setting, the exposure metering scheme switching, and whether or not digital zooming is used. The photographing apparatus 1 operates according to the conditions set on this menu screen.

The DISP button is used for inputting an instruction to switch display content on the monitor 30 and so on, and the BACK button is used for inputting an instruction to cancel an input operation and so on.

The flash light-emitting unit 36, which consists of, for example, a discharge tube (xenon tube), emits light as needed when photographing a dark subject or a backlit subject, etc. The flash control unit 38 includes a main condenser for supplying current to make the flash light-emitting unit (discharge tube) 36 emit light, and controls the battery charge for the main condenser, the timing for discharge (light emitting) and discharge time for the flash light-emitting unit 36 and so on according to a flash light emitting instruction from the CPU 12.

Next, the photographing function of the photographing apparatus 1 is described. A photographing unit 10 includes a photographing lens 40 (a zoom lens 42, a focus lens 44, and a diaphragm 46), a zoom lens control unit (Z lens control unit) 42C, a focus lens control unit (F lens control unit) 44C, a diaphragm control unit 46C, an image sensor 48, a timing generator (TG) 50, an analog single processing unit 52, an A/D converter 54, an image input controller 56, and a digital signal processing unit 58. In FIG. 2, the components in the photographing units 10-1, 10-2, . . . 10N are provided with reference numerals 1, . . . N, respectively.

The zoom lens 42 moves forward and backward along the optical axis by being driven by a zoom actuator not shown. The CPU 12 controls the position of the zoom lens 42 to perform zooming, by controlling the driving of the zoom actuator via the zoom lens control unit 42C.

The focus lens 44, moves forward and backward along the optical axis by being driven by a focus actuator not shown. The CPU 12 controls the position of the focus lens 44 to perform focusing, by controlling the driving of the focus actuator via the focus lens control unit 44C.

The diaphragm 46, which consists of, for example, an iris diaphragm, operates by being driven by a diaphragm actuator not shown. The CPU 12 controls the aperture amount (diaphragm stop) of the diaphragm 46 to control the amount of light entering the image sensor 48 by controlling the driving of the diaphragm actuator via a diaphragm control unit 46C.

The CPU 12 synchronously drives the photographing lenses 40-1, 40-2, . . . 40-N in the photographing units. In other words, the focuses of the photographing lenses 40-1, 40-2, . . . 40-N are adjusted so that they are set to always have the same focal length (zoom magnification), and always comes into focus on the same subject. Also, the diaphragm is adjusted so that they always have the same incident light amount (diaphragm stop).

The image sensor 48 consists of, for example, a color CCD solid-state image sensor. On the acceptance surface of the image sensor (CCD) 48, multiple photodiodes are two-dimensionally arranged, and on each photodiode, color filters are disposed in a predetermined arrangement. An optical image of a subject imaged on the acceptance surface of the CCD via the photographing lens 40 is converted by these photodiodes to signal charge according to the amount of incident light. The signal charge accumulated in the respective photodiodes are sequentially read from the image sensor 48 as voltage signals (image signals) according to the signal charge based on drive pulses given by the TG 50 according to an instruction from the CPU 12. The image sensor 48 includes an electronic shutter function, and the exposure time length (shutter speed) is controlled by controlling the length of time during which the photodiodes are accumulated in the photodiodes.

In this embodiment, a CCD is used as the image sensor 48, but an image sensor with another configuration, such as a CMOS sensor, can also be used.

The analog signal processing unit 52 includes a correlated double sampling circuit (CDS) for removing reset noises (low frequency wave) contained in an image signal output from the image sensor 48, and an AGS circuit for amplifying an image signal to control it to have a certain level of magnitude, and it performs correlated double sampling processing on an image signal output from the image sensor 48 and amplifies it.

The A/D converter 54 converts an analog image signal output from the analog signal processing unit 52 to a digital image signal.

The image input controller 56 loads the image signal output from the A/D converter 54 and stores it in the SDRAM 26.

The digital signal processing unit 58 functions as image processing means including a synchronization circuit (a processing circuit that interpolates color signal spatial skew due to a color filter arrangement on a single-plate CCD to convert the color signals into ones synchronized with each other), a white balance adjustment circuit, a gradation conversion processing circuit (for example, a gamma correction circuit), a contour correction circuit, a luminance and color difference signal generation circuit and so on, and performs predetermined signal processing on R, G and B image signals stored in the SDRAM 26. In other words, the R, G and B image signals are converted into a YUV signal consisting of a luminance signal (Y signal) and color difference signals (Cr and Cb signals) in the digital signal processing unit 58, and predetermined processing, such as gradation conversion processing (for example, gamma correction) is performed on the signal. The image data processed by the digital signal processing unit 58 is stored in the VRAM 28.

When a photographed image is output to the monitor 30, the image data is read from the VRAM 28, and sent to the display control unit 32 via the bus 20. The display control unit 32 converts the input image data to video signals in a predetermined format for display, and outputs them to the monitor 30.

An AF detection unit 60 loads signals for respective colors R, G and B loaded from any one of image input controllers 56-1, 56-2, . . . 56-N, and calculates a focal point evaluation value necessary for AF control. The AF detection unit 60 includes a high-pass filter that allows only the high-frequency components of the G signal to pass through, an absolute value setting processing part, a focus area extraction part that clips signals in a predetermined focus area set on the screen, an integrator part that adds up absolute value data in the focus area, and outputs the absolute value data in the focus area, which has been added up by the integrator part, to the CPU 12 as the focal point evaluation value.

During the AF control, the CPU 12 searches the position where the focal point evaluation value output from the AF detection unit 60 becomes local maximum, and moves the focus lens 42 to that position, thereby performing focusing on the main subject. In other word, the CPU 12, during AF control, first moves the focus lens 42 from close range to infinity, and in the course of that movement, sequentially acquires the focal point evaluation value from the AF detection unit 60 and detects the position where the focal point evaluation value becomes local maximum. Then, it judges the detected position where the focal point evaluation value becomes local maximum as a focused position, and moves the focus lens 42 to that position. As a result, the subject positioned in the focus area (the main photographic subject) is focused on.

An AE/AWB detection unit 62 loads image signals of respective colors R, G and B loaded from any one of the image input controllers 56-1, 56-2, . . . 56-N, and calculates an integration value necessary for AE control and AWB control. In other words, the AE/AWB detection unit 62 divides one screen into a plurality of areas (for example, 8×8=64 areas), and calculates an integration value of the R, G and B signals for each of the divided areas.

During AE control, the CPU 12 acquires an integration value of the R, G and B signals for each area, which has been calculated in the AE/AWB detection unit 62, calculates the brightness (photometrical value) of the subject, and sets the exposure for acquiring an adequate exposure amount, i.e., sets the photographic sensitivity, the diaphragm stop, the shutter speed, and whether or not strobe light flashing is necessary.

Also, during AWB control, the CPU 12 inputs the integration value of the R, G and B signals for each area, which has been calculated by the AE/AWB detection unit 62, into the digital signal processing unit 58. The digital signal processing unit 58 calculates a gain value for white balance adjustment based on the integration value calculated by the AE/AWB detection unit 62. In addition, the digital signal processing unit 58 detects the light source type based on the integration value calculated by the AE/AWB detection unit 62.

A compression/expansion processing unit 64 performs compression processing on input image data according to an instruction from the CPU 12 to generate compressed image data in a predetermined format. For example, compression processing that conforms to the JPEG standards is performed on a still image, while compressing processing that conforms to the MPEG2, MPEG4 or H.264 standards is performed on a moving image. In addition, the compression/expansion processing unit 64 performs expansion processing on input compressed image data according to an instruction from the CPU 12 to generate uncompressed image data.

An image file generation unit 66 generates a recording image file having a plurality of files in the JPEG format, which has been generated by the above compression/expansion processing unit 64, stored therein.

A media control unit 68 controls the reading/writing of data from/to a memory card 70 according to an instruction from the CPU 12.

### [Recording Image File Configuration]

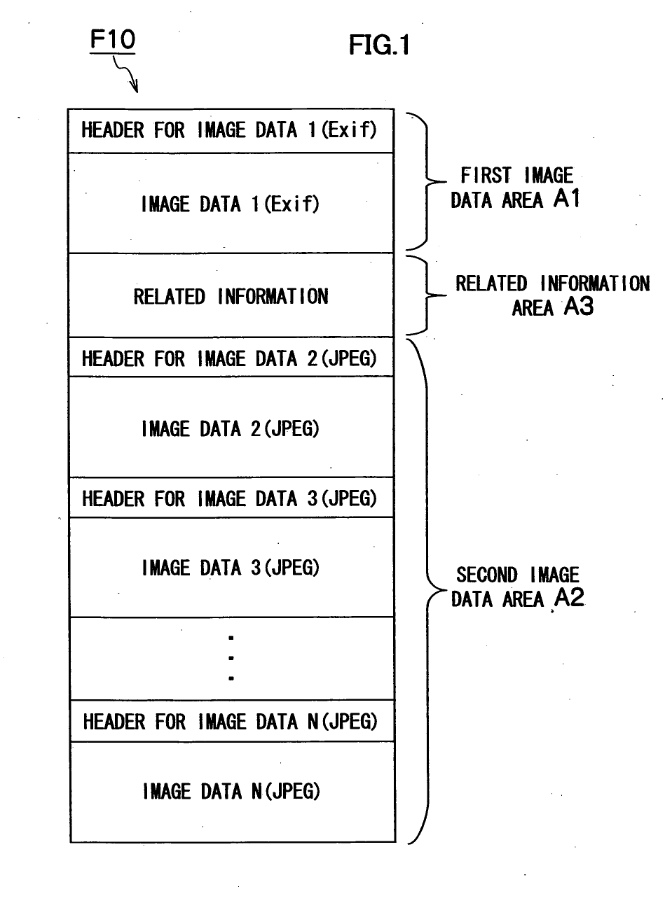

FIG. 1 is a diagram illustrating the configuration of a recording image file according to the first embodiment of the present invention. As shown in FIG. 1, a recording image file F10 according to this embodiment includes a first image data area A1, a related information area A3, and a second image data area A2.

One set of image data and a header for the image data is stored in the first image data area A1, plural sets of image data and a header for the image data can be stored in the second image data area A2. The photographing apparatus 1 according to this embodiment stores image data 1 acquired via the photographing unit 10-1 in the first image data area A1, and stores one or more image data (image data 2 to N, respectively, N is an integer more than 2.) acquired by the photographing units 10-2 to 10-N in the second image data area A2. In this example, the number of image data stored in the second image data area A2 is “N−1”, however, the number of image data to be stored in the second image data area A2 is at least one.

In the example shown in FIG. 1, the image data 1 is in the Exit format, and the image data 2 to N is in the JPEG format, but they are not limited to these. In other words, the formats for image data 1 to N may be different from each other, and may also be all the same. Furthermore, the format for each image data may be a standard format other than the above (for example, the TIFF format, the bitmap (BMP) format, the GIF format, or the PNG format, etc.).

The related information area A3 is disposed between the first image data area A1 and the second image data area A2. The related information area A3 stores related information that is related information relating to image data and is in common to at least two of the image data 1 to N stored the first image data area A1 and the second image data area A2.

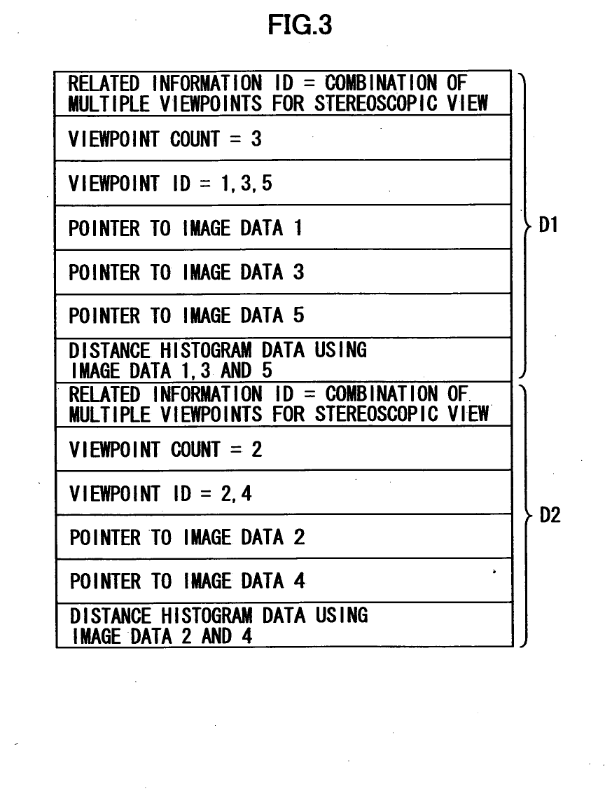

FIG. 3 is a diagram illustrating the configuration of related information. FIG. 3 shows two related information D1 and D2.

The related information D1 and D2 each contain an identifier (related information ID) for identifying data type of the related information. The value of the related information ID for related information pieces D1 and D2 is “COMBINATION OF MULTIPLE VIEWPOINTS FOR STEREOSCOPIC VIEW”, and it indicates that the related information D1 and D2 are information used for conducting stereoscopic display by combining two or more of the multiple viewpoint image data 1 to N.

In FIG. 3, the viewpoint count indicates the number of image data used for conducting stereoscopic display. A viewpoint ID is information for designating image data used when conducting stereoscopic display. For example, the viewpoint ID=“1, 3, 5” for the related information D1 indicates stereoscopic display is conducted using image data 1, 3 and 5. A pointer is a pointer for designating the position to start the reading of each image data in the recording image file F10. Distance histogram data is data indicating the distance to a subject (for example, a main subject person), which has been generated based on image data designated by the viewpoint ID.

According to this embodiment, related information that is in common to a plurality of image data can easily be recorded in a recording image file storing the plurality of image data. Also, according to this embodiment, when storing parallax images taken from multiple viewpoints for a stereoscopic view in one recording image file, related information used for generating image data for stereoscopic display can be stored in the same file.

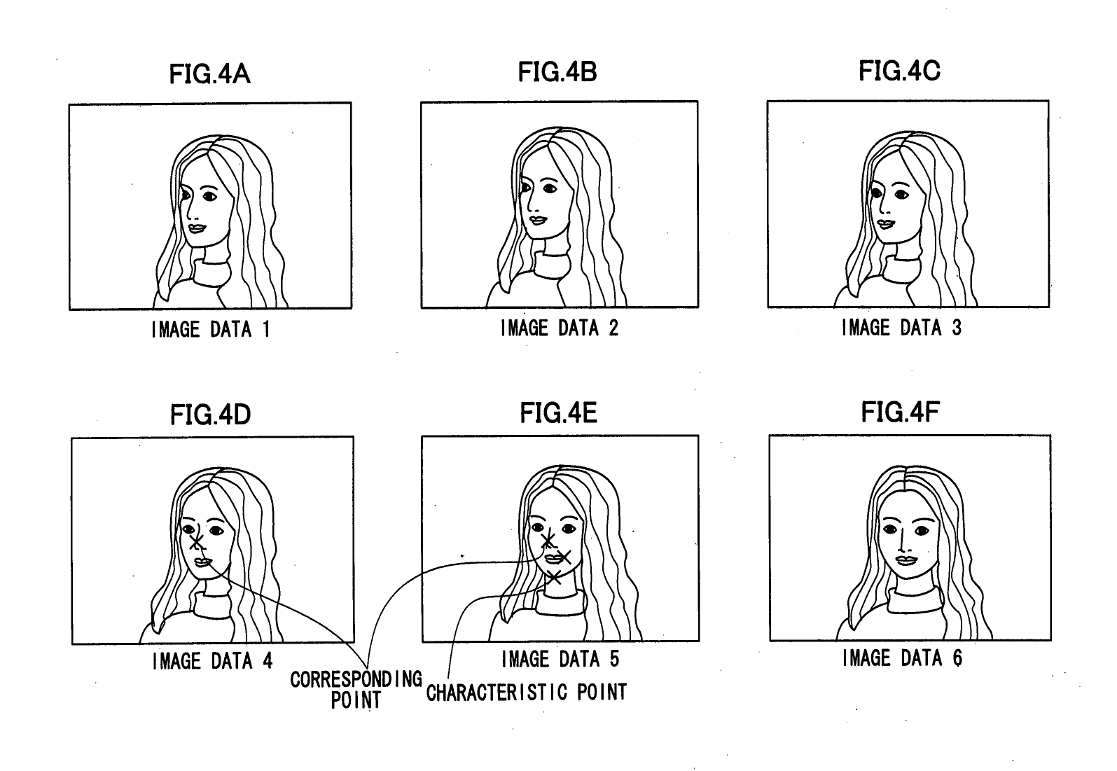

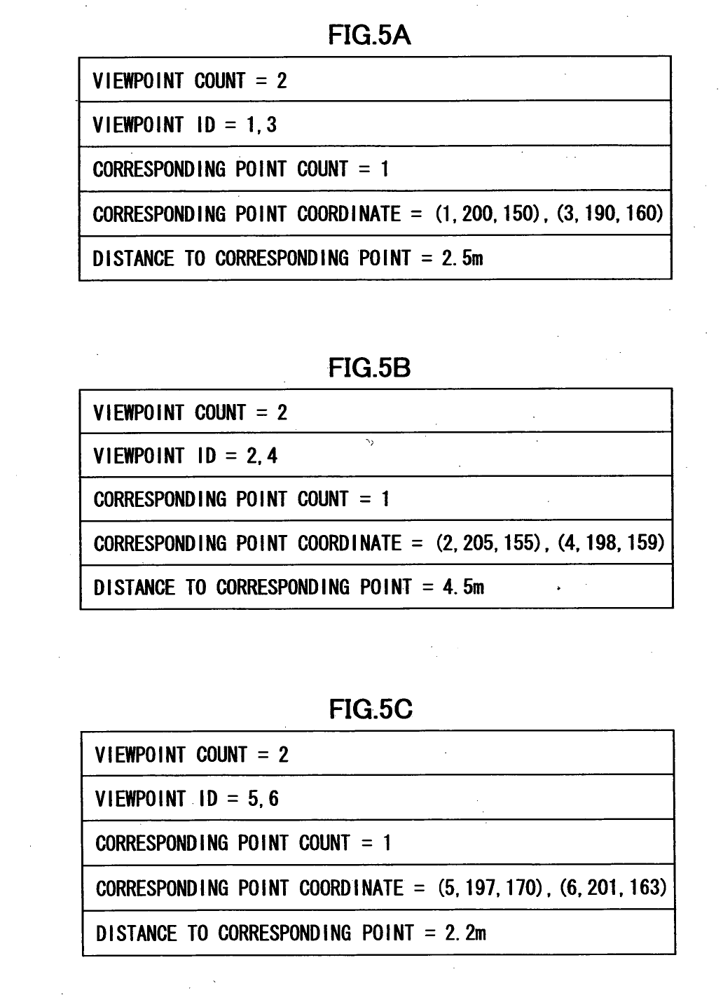

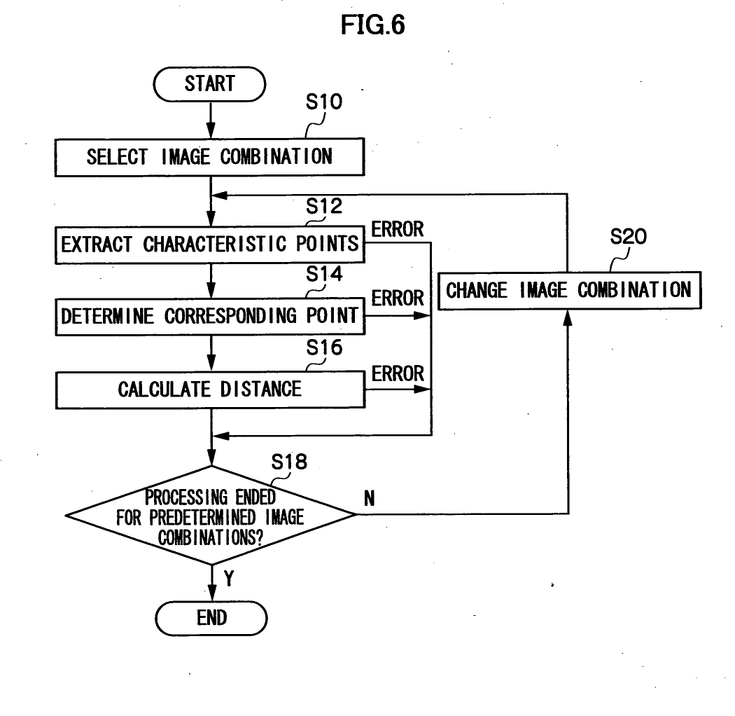

Next, distance histogram data will be described. FIGS. 4A to 4F show diagrams illustrating an image data example. FIGS. 5A to 5C show diagrams illustrating distance histogram data generated from the image data in FIGS. 4A to 4F. FIG. 6 is a flowchart for indicating a process of generating distance histogram data.

In the example shown in FIGS. 4A to 4F, there are six image data. When generating distance histogram data, first, a plurality of image data used for generating distance histogram data is selected from image data 1 to 6 (step S10). Next, characteristic points are extracted from the image data selected at step S10 (step S12). Here, the characteristic points are points at which the color in the image changes, such as an eye, a nose tip, a mouth edge (mouth corner) or a chin tip (jaw point) of a subject person, for example. The eye, the nose tip, the mouth edge (mouth corner) or the chin tip (jaw point) of the subject person is detected by a face detection technology.

Next, a corresponding point is determined from the characteristic points extracted at step S12 (step S14). Here, the corresponding point is a point in each of the plurality of image data selected at step S10, from among the characteristic points, corresponding to each other. In the example shown in FIG. 4, the corresponding point is the nose tip.

Next, the distance from the photographing apparatus 1 to the corresponding point at the time of photographing is calculated based on the positional relationship of the photographing units 10 used for photographing the above plurality of image data and the coordinate of the corresponding point (the corresponding point coordinate) in the above plurality of image data (step S16). Then, the identifiers (viewpoint IDs), the corresponding point coordinate and the corresponding point distances for the image data selected at step S10 are stored as distance histogram data.

Next, a combination of image data used for generating distance histogram data is changed (“No” in step S18 and step S20), and the processing returns to step S12. Also, when an error occurs in the calculation in the processes in step S12 to S16, the processing advances to step S18, and the combination of image data used for generating distance histogram data is changed (step S20).

Then, when the processes at steps S12 to S20 are repeated and distance histogram data generation based on every image data combination is finished (“Yes” in step S18), the processing ends. Consequently, distance histogram data as shown in FIG. 5 are generated.

In FIG. 5A, viewpoint ID=1, 3 indicates that it is distance histogram data generated based on image data 1 and 3. Also, the corresponding point coordinate=(1,200,150) indicates that the position of the corresponding point in the image data 1 is X=200 (pixels) and Y=150 (pixels), and the corresponding point coordinate=(3,190,160) indicates that the position of the corresponding point in the image data 3 is X=190 (pixels) and Y=160 (pixels). Also, the corresponding point distance=2.5 m in FIG. 5A indicates that the distance to the corresponding point calculated from the combination of the image data 1 and 3 is 2.5 m.

Also, in the examples shown in FIGS. 5B and 5C, the distance to the corresponding point calculated from the combination of the image data 2 and 4 is 4.5 m and the distance to the corresponding point calculated from the combination of the image data 5 and 6 is 2.2 m.

In the examples shown in FIGS. 5A to 5C, the distance to the corresponding point calculated from the combination of the image data 1 and 3, that is, 2.5 m, and the distance to the corresponding point calculated from the combination of the image data 5 and 6, that is, 2.2 m, are close values, while the distance to the corresponding point calculated from the combination of the image data 2 and 4, that is, 4.5 m, is a greatly deviated from them (i.e., greatly deviated from a reference value [an arbitrary value, for example, an average value, or mode value]). Therefore, distance calculation based on the combination of the image data 2 and 4 can be judged as being low in validity.

As described above, according to this embodiment, storing the distance to a corresponding point in the recording image file F10 as related information makes it possible to judge the validity of distance calculation based on the combination of image data used for calculating the distance to that corresponding point, based on its deviation from a reference value for the distance to the corresponding point. For example, during editing image data or when conducting stereoscopic display, using a combination of image data with high distance calculation validity makes it possible to achieve stereoscopic display with more realistic sensation.

In the above example, the corresponding point coordinate and the corresponding point distance are stored as distance histogram data, but it is also possible to calculate a distance to a corresponding point for each of a plurality of corresponding points and store them.

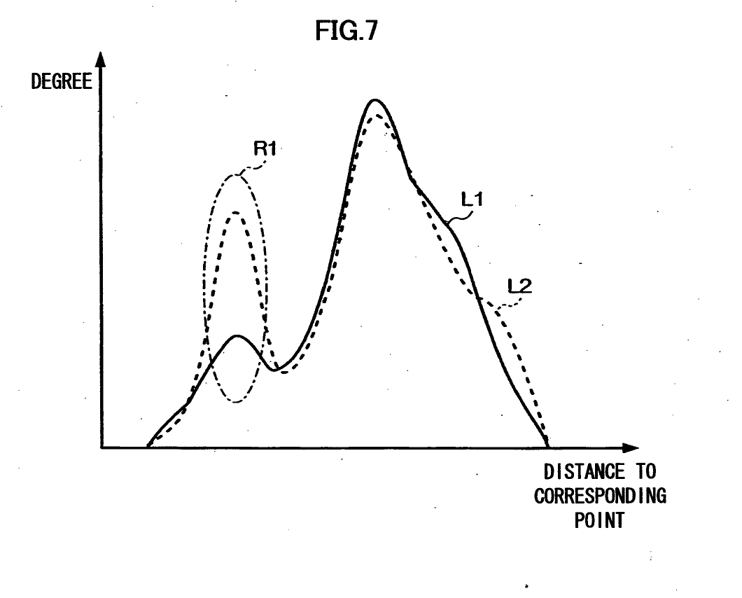

FIG. 7 is a graph indicating distance histogram data calculated for a plurality of corresponding points. In FIG. 7, the horizontal axis indicates the distance to the corresponding point, and the vertical axis indicates an accumulated value (degree) for the number of corresponding points with the same corresponding point distance (or with the corresponding point distance within a predetermined range). Data L1 is distance histogram data generated based on the image data 1 and 2, and data L2 is distance histogram data generated based on the image data 3 and 4. In the example shown in FIG. 7, the deviation in degree is great in a region R1, so an error in distance calculation will be large in the region R1. Accordingly, as shown in FIG. 7, the validity of distance calculation can be judged for each region of a screen by calculating the corresponding point distances for the plurality of corresponding points and storing them in the recording image file F10 as related information.

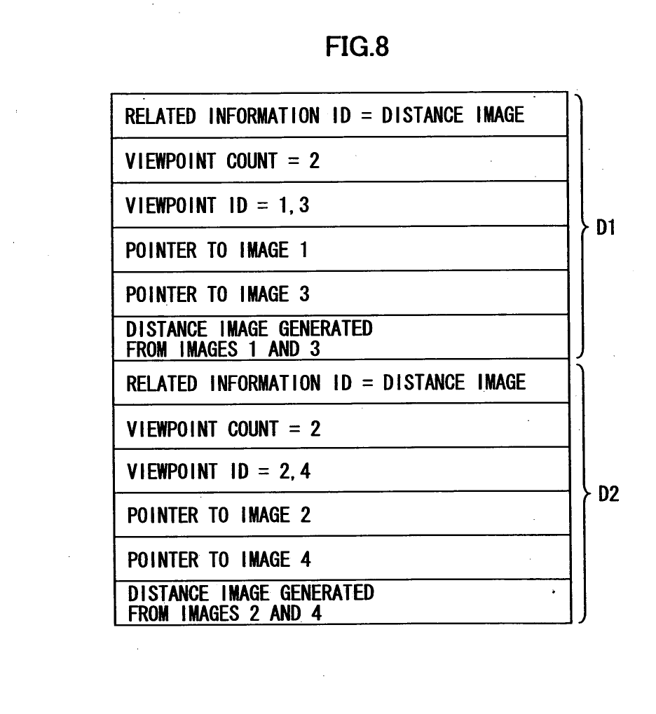

In addition, as shown in FIG. 8, a distance image that indicates distances to a subject at the time of photographing may be stored as related information. In those cases, as in the FIG. 7 example, the validity of the distance calculation can be judged for each of the regions on the screen.

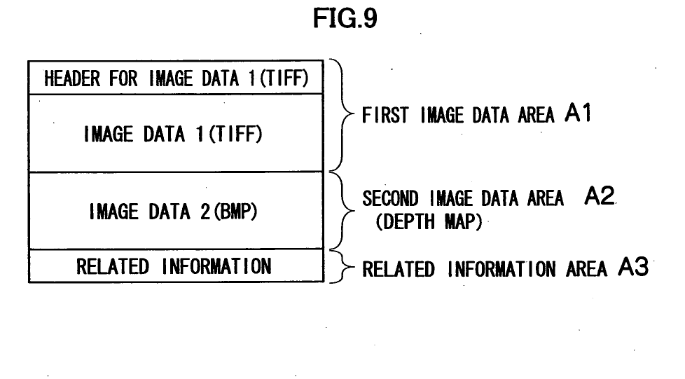

Furthermore, as shown in FIG. 9, a depth image (Depth Map: image data representing the depth of the corresponding point in image data by means of black and white gradation) can be stored in the second image data area A2. Also, the format for the depth image is not limited to the bitmap (BMP).

### Second Embodiment

Next, a second embodiment of the present invention is described. The configurations of the photographing apparatus 1, etc., is similar to those in the first embodiment.

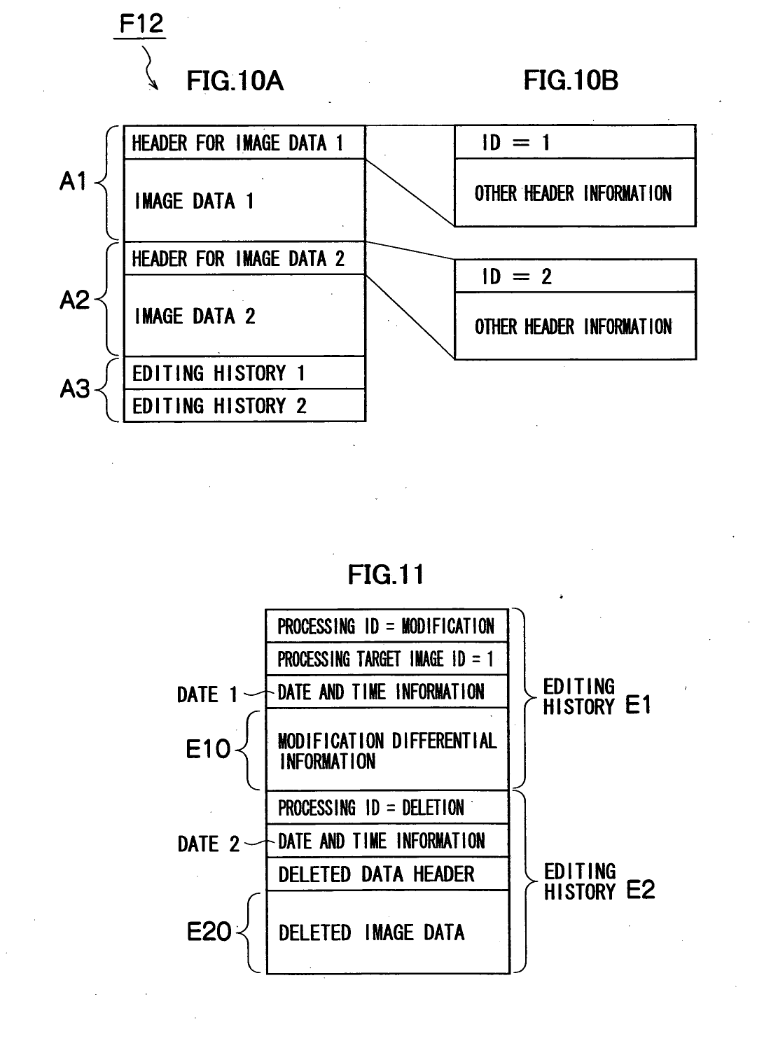

FIGS. 10A and 10B show diagrams illustrating the configuration of a recording image file according to the second embodiment of the present invention. As shown in FIG. 10A, a recording image file F12 according to this embodiment includes a first image data area A1, a second image data area A2, and related information area A3.

The first image data area A1 and the second image data area A2 each store image data and a header for that image data. As shown in FIG. 10B, the header for each image data includes an identifier (ID) unique to each image data in the recording image file F12.

The related information area A3 is disposed behind the first image data area A1 and the second image data area A2. In this embodiment, editing history information data for image data stored in the first image data area A1 and the second image data area A2 are stored in the related information area A3.

FIG. 11 is a diagram showing an example of editing history information. FIG. 11 shows two editing history information data E1 and E2.

The editing history information data E1 and E2 each includes an identifier for identifying the editing processing content (processing ID), an ID for image data that is the target for the editing processing (processing target image ID), information on the date and time when the editing processing is performed and the processing content data area (E10 and E20, respectively). In the editing history information data E1, the processing ID=“MODIFICATION”, the processing target image ID=1, and the date when the image data 1 is modified is DATE 1 are indicated. Modification differential information corresponding to the modification content of the image data is stored in a processing content data area E10 in the editing history information data E1.

Meanwhile, in the editing history information data E2, the processing ID=“DELETION”, and the date when a part of the image data in the recording image file F12 is deleted is DATE 2 are indicated. The deleted image data and its header information (deleted-data header) are stored in a processing content data area E20 in the editing history information data E2.

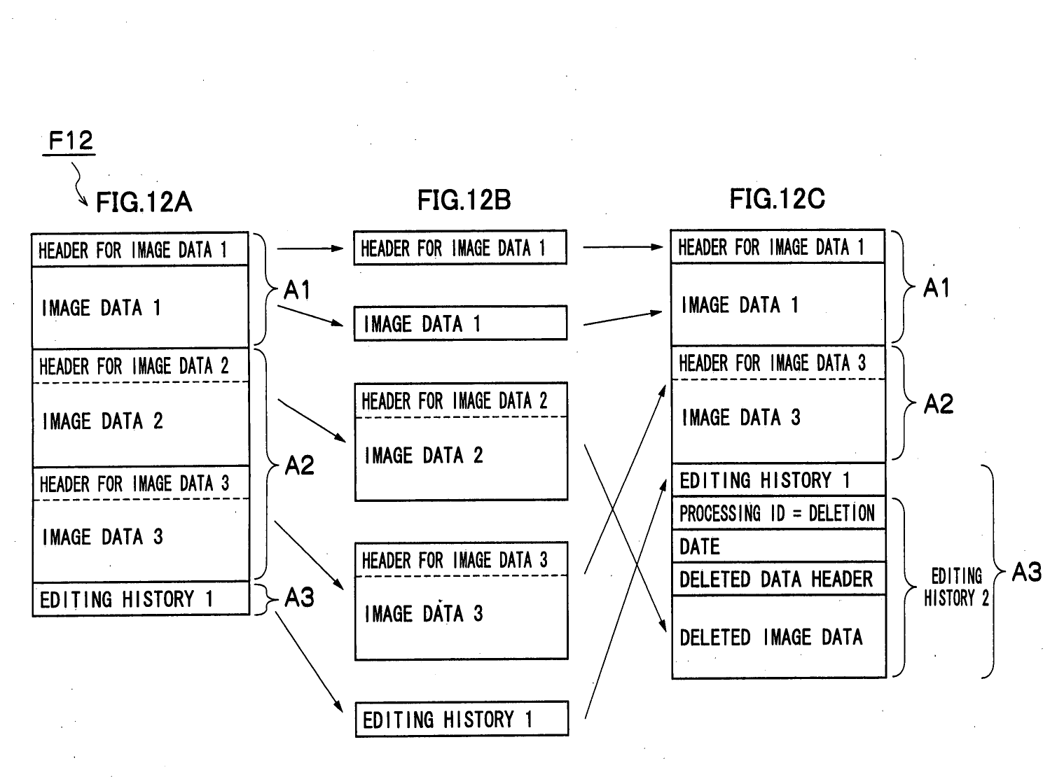

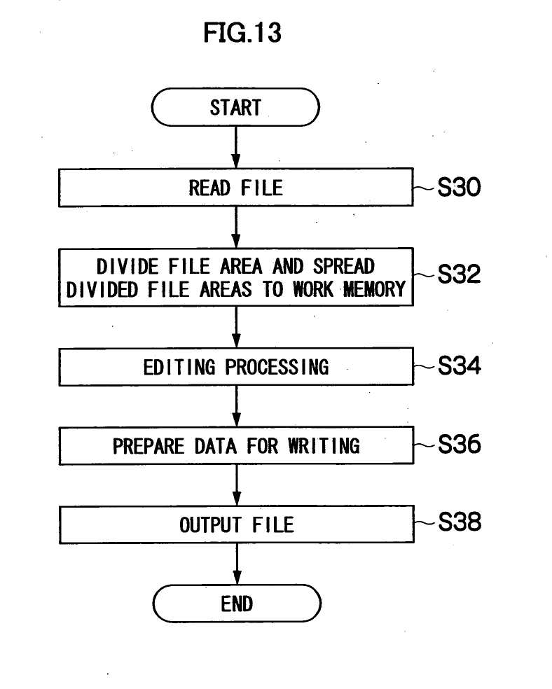

Next, editing processing for the recording image file F12 will be described. FIGS. 12A to 12C show diagrams schematically illustrating editing processing for the recording image file F12, and FIG. 13 is a flowchart illustrating a process of editing the recording image file F12.

First, the recording image file F12 is read from the memory card 70 (step S30), and as shown in FIG. 12B, it is divided into image data, header information for the image data and related information (editing history information), and spread in the SDRAM (work memory) 26 (step S32).

Next, editing processing is performed on the image data deployed in the SDRAM 26 or its header in response to an input from the operating unit 14 (step S34), and then the plurality of divided image data are combined and editing history information corresponding to the editing processing content at step S34 is written to the related information area A3 (step S36), and a recoding image file is then generated and output to the memory card 70 (step S38). For example, when the image data is modified, modification differential information is written together with processing target image ID corresponding to the modified image data, and the modification date and time. Alternatively, when image data is deleted, as shown in FIG. 12C, the deleted image data and its header information are written together with the deletion date and time.

According to this embodiment, in a recording image file including a plurality of image data, storing editing history information for each of the image data makes it possible to perform the same editing processing on the plurality of image data. It also makes it possible to restore the recording image file F12 to the state before the editing processing using the editing history information.

### Third Embodiment

Next, a third embodiment according to the present invention will be described. The configurations of the photographing apparatus 1, etc., are similar to those in the first embodiment.

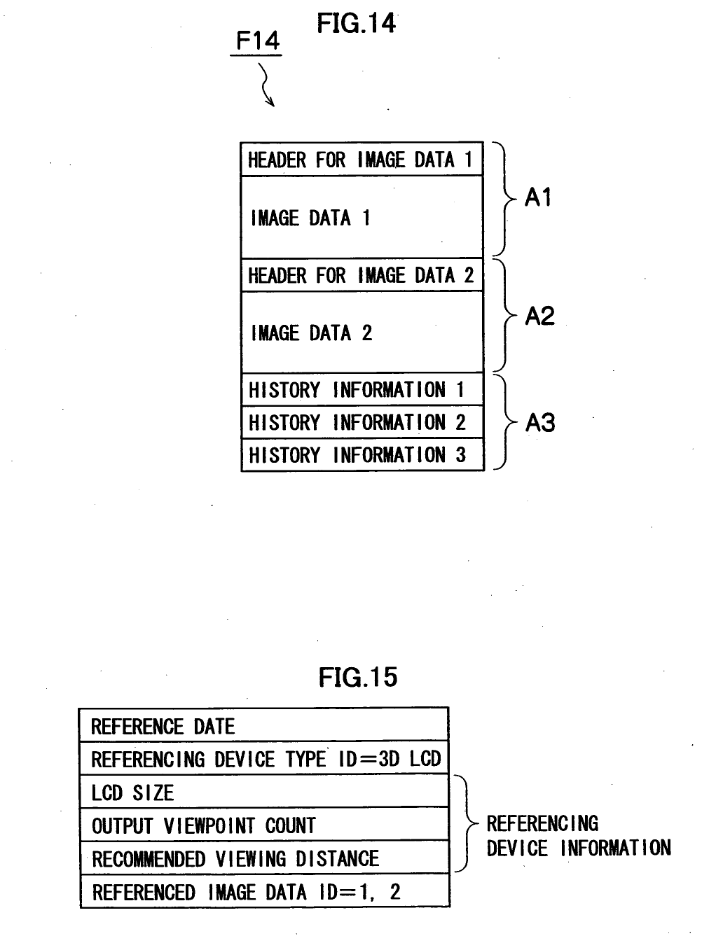

FIG. 14 is a diagram illustrating the configuration of a recording image file according to the third embodiment of the present invention. As shown in FIG. 14, a recording image file F14 according to this embodiment includes a first image data area A1, a second image data area A2, and a related information area A3.

Image data and a header for the image data are stored in each of the first image data area A1 and the second image data area A2.

As shown in FIG. 14, the related information area A3 is disposed behind the first image data area A1 and the second image data area A2. In this embodiment, reference history information indicating the history of image data stored in the first image data area A1 and the second image data area A2 being output to a monitor 30, an external display device or a printer, etc., is stored in the related information area A3.

FIG. 15 is a diagram illustrating reference history information. The reference history information includes information on the date and time when the image data is referenced, a referencing device type ID indicating the type of device to which the image data was output (the monitor 30, the external display device or the printer), and a referencing device information and an information for identifying the referenced image data (referenced image data ID). In the example shown in FIG. 15, the referencing device type ID=3D LCD, and the referenced image data ID=1, 2, which indicates that the device to which the image data 1 and 2 was output is an LCD monitor that allows three-dimensional display. Also, the referencing device information is information relating to an output destination device, which is acquired from that device, and it is, for example, the size of the above LCD monitor, the number of output viewpoints (output viewpoint count) corresponding to the number of image data used for generating data for stereoscopic display, and recommended viewing distance for viewing the above LCD monitor (distance suitable for stereoscopic viewing).

According to this embodiment, referencing reference history information on each of a plurality of the image data in a recording image file containing the plurality of image data makes it possible to select the optimum referenced image data ID and viewpoint count, etc., according to, for example, the three-dimensional display function of the output destination device.

In each of the above embodiments, alteration detection data may be stored in the related information area A3.

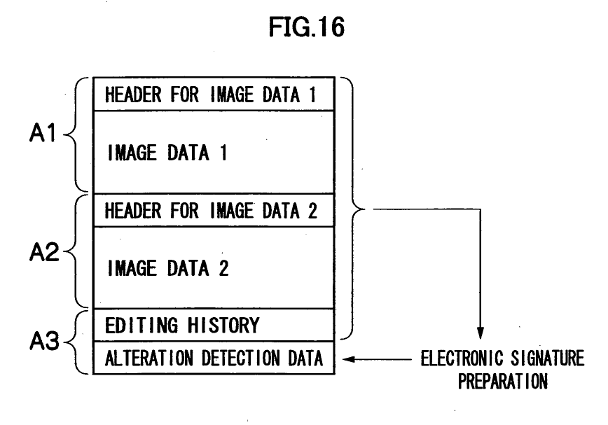

FIG. 16 is a diagram illustrating an example of alteration detection data being stored as related information.

Alteration detection data SIG1 is stored in the related information area A3 in a recording image file F16 shown in FIG. 16. The alteration, detection data SIG1 shown in FIG. 16 is an electronic signature in which data in a first image data area A1 and a second image data area A2 and editing history information are encrypted by a user's secret key. When transmitting the recording image file F16, the user publishes a public key for decrypting this electronic signature or sends it to a transmission destination user in advance so that the transmission destination user can obtain it. After receiving the recording image file F16, the transmission destination user can confirm whether or not a data alteration exists by decrypting the alteration detection data SIG1 using the above public key, and comparing it with data in the recording image file F16.

Also, the image recording device according the present invention can be obtained by employing a program that performs the above processing in an image recording device.

1. An image recording device comprising:
an image data acquiring unit which acquires first image data defined by a standard format, and at least one second image data defined by the standard format;
a related information generating unit which generates a related information relating to at least two image data from among the first and second image data;
a recording image file generating unit which generates a recording image file including a first image data area having the first image data stored therein, a second image data area having the second image data stored therein, and related information recording area having the related information stored therein; and
a recording unit which records the recording image file.

2. The image recording device according to claim 1, further comprising
an editing unit which edits the first and second image data, wherein
the related information generating unit, when the first or second image data is edited, generates an editing history information indicating the content of the editing performed on the first or second image data; and
the recording image file generating unit stores the editing history information in the related information storing area.

3. The image recording device according to claim 1, further comprising
an alteration detection data generating unit which generates alteration detection data for detecting an alteration of the first and second image data, and the related information, wherein
the recording image file generating unit stores the alteration detection data in the related information storing area.

4. The image recording device according to claim 1, wherein
the image data acquiring unit acquires image data of an identical subject photographed from multiple viewpoints using one or more photographing devices.

5. The image recording device according to claim 4, wherein
the related information generating unit generates, based on the image data, an image combination information relating to a combination of images to be used when outputting a stereoscopic image; and
the recording image file generating unit stores the image combination information in the related information storing area.

6. The image recording device according to claim 5, further comprising:
an image selecting unit which selects at least two of the image data based on the related information; and
a stereoscopic image outputting unit which converts the selected image data into a format enabling a stereoscopic view and outputs it.

7. The image recording device according to claim 6, wherein
the related information generating unit, when the selected image data is output to the stereoscopic image outputting unit, generates a reference history information indicating a history of the selected image data being output and referenced; and
the recording image file generating unit stores the reference history information in the related information storing area.

8. The image recording device according to claim 4, wherein
the related information generating unit generates distance data indicating the distances to the subject at the time of photographing the plurality of image data, based on the plurality of image data; and
the recording image file generating unit stores the distance data in the related information storing area.

9. The image recording device according to claim 8, wherein
the distance data is distance histogram data or distance image data generated based on the plurality of image data.

10. The image recording device according to claim 5, further comprising
an editing unit which edits the first and second image data, wherein
the related information generating unit, when the first or second image data is edited, generates an editing history information indicating the content of the editing performed on the first or second image data; and
the recording image file generating unit stores the editing history information in the related information storing area.

11. The image recording device according to claim 5, further comprising
an alteration detection data generating unit which generates alteration detection data for detecting an alteration of the first and second image data, and the related information, wherein
the recording image file generating unit stores the alteration detection data in the related information storing area.

12. An image recording method comprising:
an image data acquisition step of acquiring first image data defined by a standard format, and at least one second image data defined by the standard format;
a related information generation step of generating a related information relating to at least two image data from among the first and second image data;
a recording image file generation step of generating a recording image file having a first image data area having the first image data stored therein, a second image data area having the second image data stored therein, and related information recording area having the related information stored therein; and
a recording step of recording the recording image file.

13. The image recording method according to claim 12, further comprising
an editing step of editing the first and second image data, wherein
in the related information generation step, when the first or second image data is edited, an editing history information indicating the content of the editing performed on the first or second image data is generated; and
in the recording image file generation step, the editing history information is stored in the related information storing area.

14. The image recording method according to claim 12, further comprising
an alteration detection data generation step of generating alteration detection data for detecting an alteration of the first and second image data, and the related information, wherein
in the recording image file generation step, the alteration detection data is stored in the related information storing area.

15. The image recording method according to claim 12, wherein
in the image data acquisition step, image data of an identical subject photographed from multiple viewpoints using one or more photographing means is acquired.

16. The image recording method according to claim 15, wherein
in the related information generation step, an image combination information relating to a combination of images to be used is generated based on the image data when outputting a stereoscopic image; and
in the recording image file generation step, the image combination information is stored in the related information storing area.

17. The image recording method according to claim 16, further comprising:
an image selection step of selecting at least two of the image data based on the related information; and
a step of converting the selected image data into a format enabling a stereoscopic view, and outputting the converted image data to a stereoscopic image outputting device.

18. The image recording method according to claim 17, wherein
in the related information generation step, when the selected image data is output to the stereoscopic image outputting device, a reference history information indicating a history of the selected image data being output and referenced is generated; and
in the recording image file generation step, the reference history information is stored in the related information storing area.

19. The image recording method according to claim 15, wherein
in the related information generation step, distance data indicating the distances to the subject at the time of photographing the plurality of image data is generated based on the plurality of image data; and
in the recording image file generation step, the distance data is stored in the related information storing area.

20. The image recording method according to claim 19, wherein
the distance data is distance histogram data or distance image data generated based on the plurality of image data.

21. The image recording method according to claim 16, further comprising
an editing step of editing the first and second image data, wherein
in the related information generation step, when the first or second image data is edited, an editing history information indicating the content of the editing performed on the first or second image data is generated; and
in the recording image file generation step, the editing history information is stored in the related information storing area.

22. The image recording method according to claim 16, further comprising
an alteration detection data generation step of generating alteration detection data for detecting an alteration of the first and second image data, and the related information, wherein
in the recording image file generation step, the alteration detection data is stored in the related information storing area.
